(19) United States
(12) Patent Application Publication
(10) Pub. No.: US 2026/0299982 A1
(43) Pub. Date: Oct. 1, 2026

(54) SEMICONDUCTOR DEVICE

(71) Applicant: RENESAS ELECTRONICS CORPORATION, Tokyo (JP)

(72) Inventors: Yohei ONISHI, Tokyo (JP); Yuichi TAKITSUNE, Tokyo (JP)

(21) Appl. No.: 19/535,006

(22) Filed: Feb. 10, 2026

(30) Foreign Application Priority Data
Mar. 28, 2025 (JP) 2025-056410

(51) Int. Cl. G06F 9/455; G06F 12/14; G06F 21/62; G06F 21/72

(52) U.S. Cl. CPC G06F 9/45533; G06F 9/45558; G06F 12/145; G06F 21/6227; G06F 21/72; G06F 2009/45579

(57) ABSTRACT

A semiconductor device is provided, the semiconductor device including: a table for setting-register access right permission, connected to a secure CPU and storing a region ID and an address of a virtual machine; and a first combination-corresponding comparator circuit determining whether or not a region ID of a first virtual machine for changing a setting register and an address assigned by the first virtual machine correspond to the region ID and the address of the virtual machine stored in the table for setting-register access right permission.

### CROSS-REFERENCE TO RELATED APPLICATION

The disclosure of Japanese Patent Application No. 2025-056410 filed on Mar. 28, 2025, including the specification, drawings and abstract is incorporated herein by reference in its entirety.

### BACKGROUND

The present disclosure relates to a semiconductor device.

Motor vehicles have continuously evolved to have automated driving form as final form. Motor-vehicle control systems have been sophisticated and complicated such that a plurality of independent operating systems (OSs) (hereinafter each referred to as virtual machine VM) operate on a plurality of central processing units (CPUs) included in even one micro controller unit (MCU) chip. A plurality of cameras, radars, LiDARs or other sensor group are mounted for automated/semi-automated driving, and data output from them is processed by an in-vehicle MCU or System On Ship (SoC) to control a power system, a navigation system, a lighting system or others. The number of components are increased by increase in the number of such sensors and increase in the number of MCUs or SoCs in accordance with the increase. Accordingly, the number of in-vehicle communication network nodes is also increased. Also, a data amount generated by the sensor group is dramatically increased by the automated/semi-automated driving, and a necessary data communication speed has changed by ten thousand times from 1 Mbps to 10 Gbps as of this moment.

A component having a sufficient actual performance in market that is stable for communication quality and is relatively inexpensively available as a general-purpose product is Ethernet.

Therefore, application of the Ethernet to the in-vehicle communication has been the mainstream.

Generally, each VM in the MCU or SoC on which the plurality of VMs are mounted plays a role of control for each functional group. Each of the VMs performs the data communication with another externally-connected MCU or SoC through the Ethernet that is the in-vehicle communication network. At this time, the VMs share an Ethernet controller and a MAC sec mounted on the MCU or SoC, and perform communications based on each different setting of an Ethernet frame header and an encryption key, an encryption method, a MACsec header content and others necessary in use of MACsec. Particularly, regarding each different setting in use of the MACsec, each VM causes a RAM to store rule data based on a rule of the key, the encryption method, the MACsec header content or others defined by each VM together with its communication counterpart. And, a “Matched filter” is used in order to determine and make correspondence which rule is applied to the Ether frame to be transmitted/received. This Matched filter is set by a special function register (SFR).

### There is disclosed technique listed below.

Patent Document 1 Japanese Unexamined Patent Application Publication No. 2023-171267

The Patent Document 1 discloses a semiconductor device using a virtual machine.

### SUMMARY

There is a room for improvement in security of the semiconductor device using the virtual machine. Therefore, an objective of the present disclosure is to provide a semiconductor device using a virtual machine with improved security.

Other objectives and novel characteristics will be apparent from the description of the present specification and the accompanying drawings.

According to an embodiment, a semiconductor device includes a first combination-corresponding comparator circuit determining whether or not a region ID of a first virtual machine for changing a setting register and an address assigned by the first virtual machine correspond to a region ID and an address of a virtual machine stored in a table for setting-register access right permission.

According to the embodiment, a semiconductor device using a virtual machine with improved security can be provided.

### BRIEF DESCRIPTIONS OF THE DRAWINGS

FIG. 1 is a block diagram illustrating relation between a virtual machine and a MACsec according to a related art.

FIG. 2 is a diagram illustrating an example of spoofing on the virtual machine according to the related art.

FIG. 3 is a block diagram illustrating a configuration, particularly a setting register, of the MACsec according to the related art.

FIG. 4 is a block diagram illustrating an example of attack on the setting register of the MACsec according to the related art from a hacking tool.

FIG. 5 is a diagram illustrating a configuration, particularly a setting register for a RAM and the RAM, of the MACsec according to the related art.

FIG. 6 is a block diagram illustrating an example of attack on the RAM of the MACsec according to the related art from the hacking tool.

FIG. 7 is a block diagram illustrating a configuration of a MACsec according to the present disclosure.

FIG. 8 is a block diagram illustrating an example of access permission using a configuration, particularly a table for setting-register access right permission and a first combination-corresponding comparator circuit, of the MACsec according to the present disclosure.

FIG. 9 is a block diagram illustrating an example of access block using a configuration, particularly the table for setting-register access right permission and the first combination-corresponding comparator circuit, of the MACsec according to the present disclosure.

FIG. 10 is a diagram illustrating an example of access control using the table for setting-register access right permission and the first combination-corresponding comparator circuit according to the present disclosure.

FIG. 11 is a block diagram illustrating an example of access permission using a configuration, particularly a table for RAM access right permission and a second combination-corresponding comparator circuit, of the MACsec according to the present disclosure.

FIG. 12 is a block diagram illustrating an example of access block using a configuration, particularly the table for RAM access right permission and the second combination-corresponding comparator circuit, of the MACsec according to the present disclosure.

FIG. 13 is a diagram illustrating an example of access control using the table for RAM access right permission and the second combination-corresponding comparator circuit according to the present disclosure.

FIG. 14 is a block diagram illustrating an example of first isolation using a configuration, particularly an isolation controller circuit, of the MACsec according to the present disclosure.

FIG. 15 is a block diagram illustrating an example of second isolation using a configuration, particularly the isolation controller circuit, of the MACsec according to the present disclosure.

FIG. 16 is a block diagram illustrating an example of protection for the attacked virtual machine, using a configuration, particularly an error interrupt circuit, of the MACsec according to the present disclosure.

FIG. 17 is a flowchart of access control according to the present disclosure.

### DETAILED DESCRIPTION

### Explanation for MACsec according to Related Art

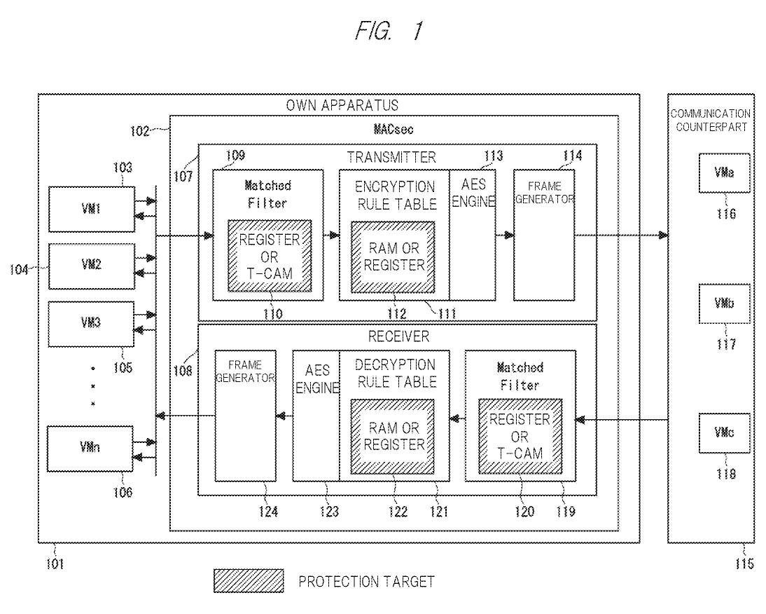

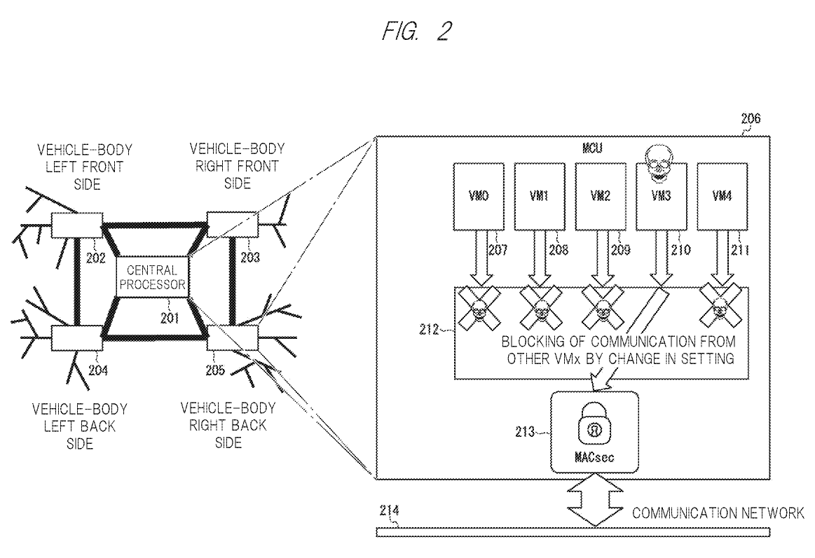

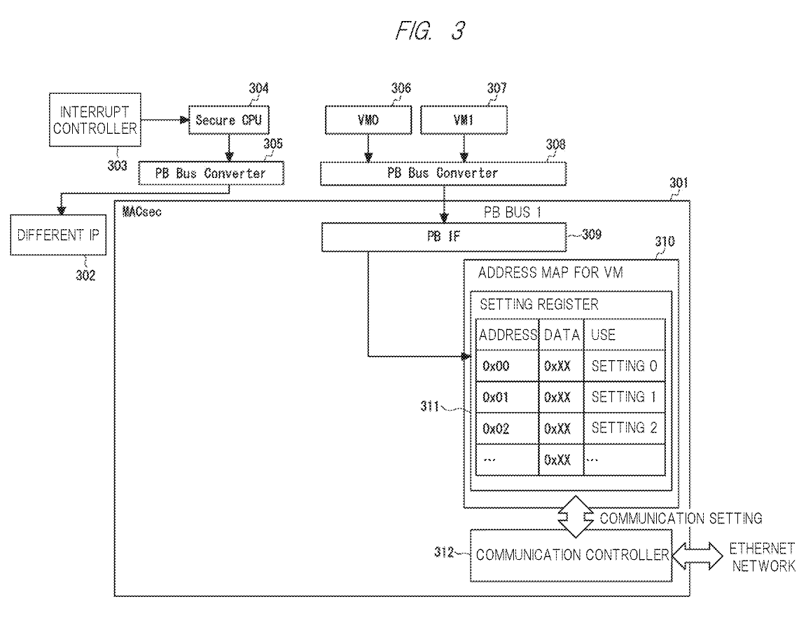

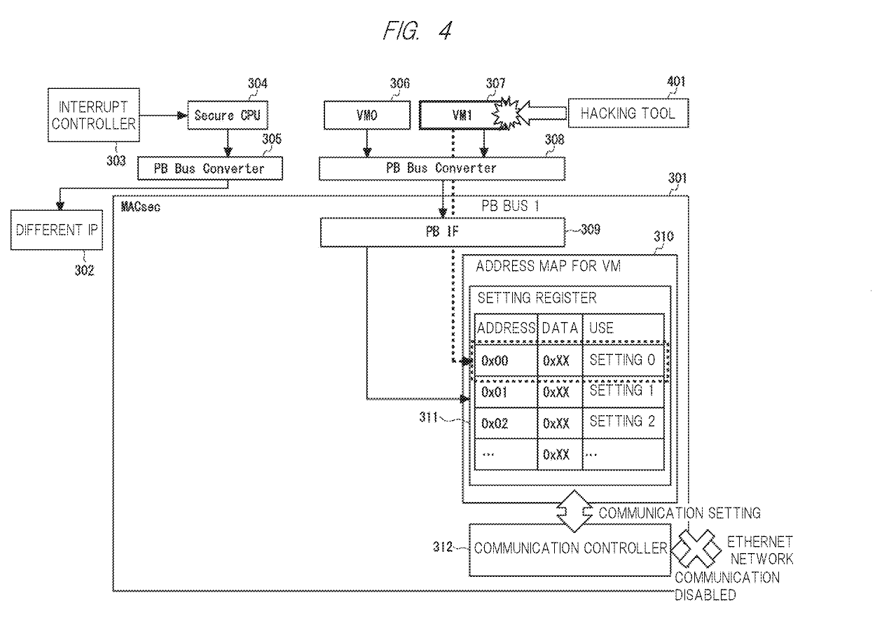

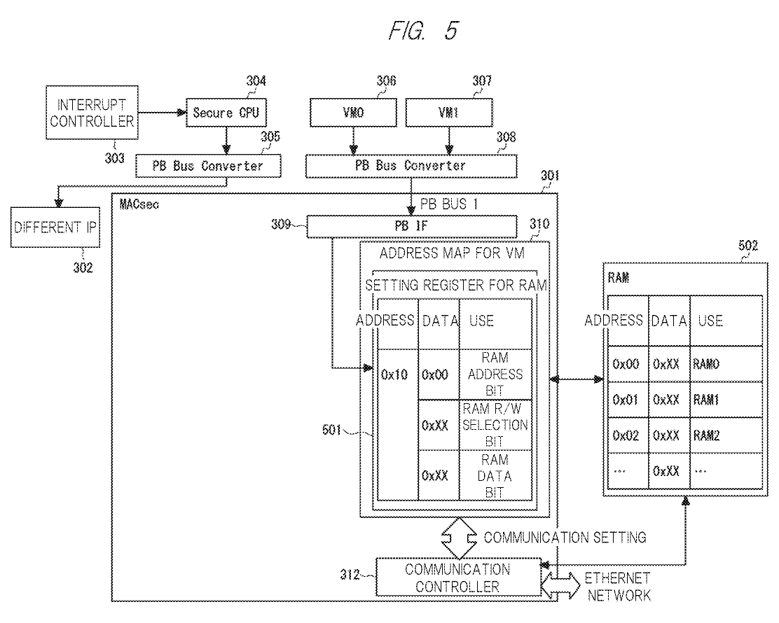

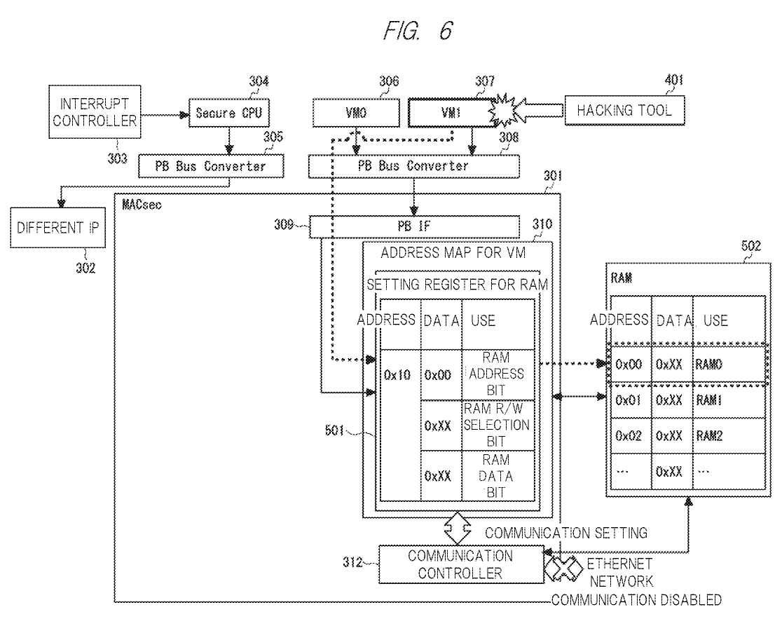

FIG. 1 is a block diagram illustrating relation between a virtual machine and a MACsec according to a related art. FIG. 2 is a diagram illustrating an example of spoofing on the virtual machine according to the related art. FIG. 3 is a block diagram illustrating a configuration, particularly a setting register, of the MACsec according to the related art. FIG. 4 is a block diagram illustrating an example of attack on the setting register of the MACsec according to the related art from a hacking tool such as a CAN invader. FIG. 5 is a diagram illustrating a configuration, particularly a RAM setting register and the RAM, of the MACsec according to the related art. FIG. 6 is a block diagram illustrating an example of attack on the RAM of the MACsec according to the related art from the hacking tool. The MACsec according to the related art will be explained with reference to FIGS. 1 to 6.

As illustrated in FIG. 1, an own apparatus 101 is an apparatus such as a vehicle having a plurality of control functions. The own apparatus 101 includes a plurality of virtual machines VM1(103), VM2(104), VM3(105), VMn(106), and a MACsec 102. The plurality of virtual machines 103, 104, 105 and 106 are connected to virtual machines VMa116, VMb117 and VMc118 of a communication counterpart apparatus 115 through the MACsec 102. The connection may be one-to-one communication or one-to-some communication.

The MACsec 102 includes a transmitter 107 and a receiver 108. The transmitter 107 includes a matched filter 109, an encryption rule table 111, an AES engine 113 and a frame generator 114. The matched filter 109 includes a register or a T-CAM 110. The encryption rule table 111 includes a RAM or a register 112.

As initial setting, an “encryption rule” and a “key” that are defined by each VM such as VM1(103) together with its own communication counterpart such as VMa116 are set in the rule table or RAM.

A filter condition is set in the matched filter 109 in order to cause each VM such as VM1(103) to make correspondence between the Ether frame that is its own plaintext and the “rule”.

The matched filter 109 determines which rule and key are to be applied to the Ether frame transmitted from each VM.

The encryption rule table 111 and the AES engine 113 encrypt the assigned data part by using the encryption rule and the key.

The frame generator 114 generates the Ether frame by combining the encrypted data part with a MAC address, a SecTag and a CRC, and transmits it.

The receiver 108 includes a matched filter 119, a decryption rule table 121, an AES engine 123 and a frame generator 124. The matched filter 119 includes a register or a T-CAM 120. The decryption rule table 121 includes a RAM or a register 122.

The matched filter 119 determines which rule and key are applied to the received frame.

The decryption rule table 121 and the AES engine 123 decrypt the assigned data part by using the decryption rule and the key.

The frame generator 124 generates the Ether frame by combining the decrypted data part with a MAC address, and transfers it to a destination VM.

As illustrated in FIG. 2, a MCU 206 that electrically controls a central processor 201, a vehicle-body left front side 202, a vehicle-body right front side 203, a vehicle-body left back side 204 and a vehicle-body right back side 202 includes a plurality of VMs that are VM0(207), VM1(208), VM2(209), VM3(210), VM4(211), a setting portion 212 and a MACsec 213. The MCU 206 is connected to a communication network 214 through the MACsec 213. The numerical terms 202 to 205 indicate functional blocks in a vehicle or positions in the vehicle. For example, each of the portions 202 to 205 may be EV & powertrain control, ADAS control or infotainment.

In the MCU or SoC on which the plurality of VM (virtual machines) are mounted, it has not been expected so far that the single or the plurality of VMs are spoofed.

However, a new risk that is the hacking on the VM has arisen due to the sophistication of the hacking technique. For example, the VM3(210) may be hacked.

Particularly in the MACsec case, when the hacked VM3(210) pretends to be a different VM, and then, when a setting value of the setting portion 212 that is the rule data or SFR of the different VM is falsified, the communication with the communication counterpart is disabled at this moment, and, accordingly, the entire in-vehicle communication network may be paralyzed.

Therefore, the MACsec needs to block/isolate the hacked VM immediately when the hacked VM executes the access for the falsification. Also, in order to prevent spreading of damage, the MACsec needs to protect the system by notifying the secure CPU or the normal (legitimate) VM of the illegitimate access and causing the secure CPU to stop/reset the hacked VM. Even in the related-art products, the spoofing on the VM can be detected by the periodic check (error notification, WDT and others) made by the secure CPU. However, the illegitimate access cannot be immediately stopped, and therefore, this technique is not sufficient to the support for the MACsec. Also, if the illegitimate access is monitored by software, a large amount of CPU resources is needed, and is problematic.

If the matched filter 109 of the register, the T-CAM 110 or the like is falsified at the time of transmission, the correspondence to the rule defined together with the communication counterpart cannot be made, and the data is encrypted under the application of the incorrect rule and then is transmitted. In this case, the reception at the communication counterpart is made erroneous, and the communication cannot be made.

Also, if the matched filter 109 of the register, the T-CAM 110 or the like is falsified at the time of transmission, the correspondence to the rule defined together with the communication counterpart cannot be made, and the data is transmitted as a plain text under application of a rule for bypassing the encryption. In this case, although the communication counterpart can receive the data, there is a risk of leakage of the Ether frame information.

If the encryption rule of the RAM, the register 112 or the like is falsified at the time of transmission, an encrypted text with a different rule for the encryption method or the key defined together with the communication counterpart is transmitted. In this case, the reception at the communication counterpart is made erroneous.

If the matched filter 119 of the register, the T-CAM 120 or the like is falsified at the time of reception, the correspondence to the rule defined together with the communication counterpart cannot be made, and the data is decrypted under application of the incorrect rule and then is received. In this case, the reception at the own apparatus 101 is made erroneous.

If the decryption rule of the RAM, the register 112 or the like is falsified at the time of reception, the data is decrypted under a different rule for the encryption method or the key defined together with the communication counterpart. In this case, the reception at the own apparatus 101 is made erroneous.

As illustrated in FIG. 3, the MACsec 301 includes a peripheral bus interface (PB IF) 309, an address map 310 for VM, and a communication control portion 312. The address map 310 for VM includes a setting register (SFR) 311.

The secure CPU 304 controlled by the interrupt controller 303 may control the MACsec 301 through a PB bus converter 305. In this case, a different IP 302 is controlled.

The MACsec 301 is connected to the PB IF 309 of the MACsec 301 through, for example, the VM0(306), the VM1(307) and a PB bus converter 308.

The VM0(306) and the VM1(307) access the setting register 311. As illustrated in FIG. 4, when the hacking tool 401 hacks the VM1(307) such that the VM1(307) is spoofed, the VM1(307) may access the setting register 311, and may change, for example, the setting on the VM0(306). Due to the rewriting on the setting register 311, the communication control portion 312 cannot make the communication with outside.

Also, as illustrated in FIG. 5, the address map 310 for VM includes a setting register 501 for RAM. The VM0(306) and the VM1(307) access a RAM 502 through the setting register 501 for RAM.

As illustrated in FIG. 6, when the hacking tool 401 hacks the VM1(307) such that the VM1(307) is spoofed, the VM1(307) may access the RAM 502 through the setting register 501 for RAM, and may change, for example, the RAM data to be set by the VM0(306). Due to the rewriting on the RAM data, the communication control portion 312 connected with the RAM 502 through the Ether network cannot make the communication with outside.

### Explanation for Semiconductor Device according to Embodiment

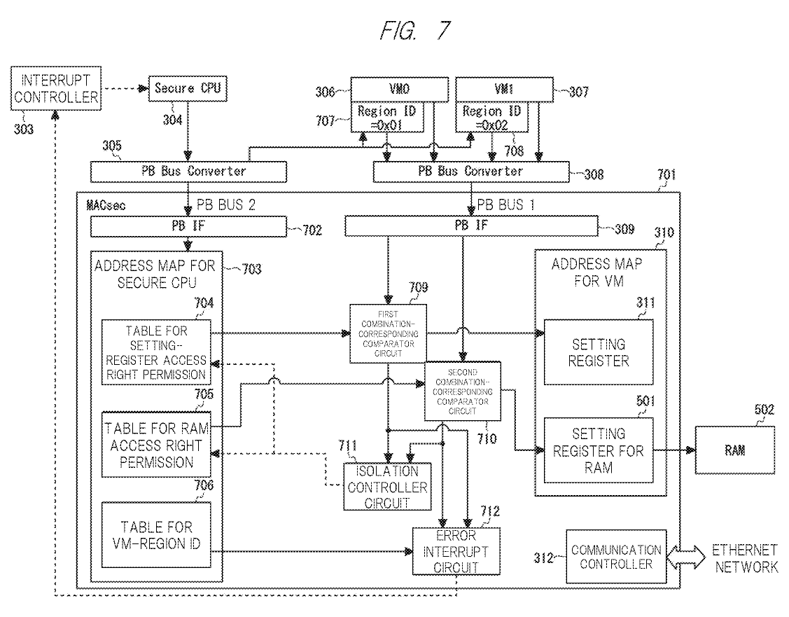

FIG. 7 is a block diagram illustrating a configuration of a MACsec according to the present disclosure. A semiconductor device according to the present disclosure will be explained with reference to FIG. 7. The MACsec is made of the semiconductor device using a semiconductor.

As illustrated in FIG. 7, a MACsec 701 according to the present disclosure includes a PB IF 702, an address map 703 for secure CPU, a first combination-corresponding comparator circuit 709, a second combination-corresponding comparator circuit 710, an isolation controller circuit 711 and an error interrupt circuit 712 in addition to the MACsec 301 according to the related art.

The address map 703 for secure CPU includes a table 704 for setting-register access right permission, a table 705 for RAM access right permission, and a table 706 for VM-Region ID (virtual machine-region ID table). The address map 703 for secure CPU is connected to the secure CPU 304 through the PB bus converter 305 and the PB IF 702. The address map 703 for secure CPU is to be protected to be set by only the secure CPU 304. That is, a PB bus for secure CPU is different from a PB bus for VM. Each bus has an accessible address map. Therefore, the address map 703 for secure CPU is robust.

The secure CPU 304 sets a unique value for a region ID of each VM. For example, by the secure CPU 304, a region ID 707 is set for the VM0(306), and a region ID 708 is set for the VM1(307). When the MACsec 701 is accessed, the region ID is passed as accessorial information and a “PUSER” of PB.

The table 704 for setting-register access right permission and the first combination-corresponding comparator circuit 709 are used for the block. The table 705 for RAM access right permission and the second combination-corresponding comparator circuit 710 are used for the block. The isolation controller circuit 711 is used for the isolation. The error interrupt circuit 712 is used for the protection.

The block means that the secure CPU 304 assigns a region where the key information, the setting register or the like can be set for each VM, and denies an access other than an access from the VM assigned by the MACsec 701.

The isolation means that, when the MACsec 701 blocks the illegitimate access, the MACsec 701 stops the access right of this VM, and denies all accesses after that.

The protection means that, when the MACsec 701 blocks the illegitimate access, the MACsec 701 notifies the secure CPU 304 of the execution of the illegitimate access, and then, the notified secure CPU 304 stops the VM having executed the illegitimate access and restores it by reset or the like.

### Explanation for First Block of Semiconductor Device according to Embodiment

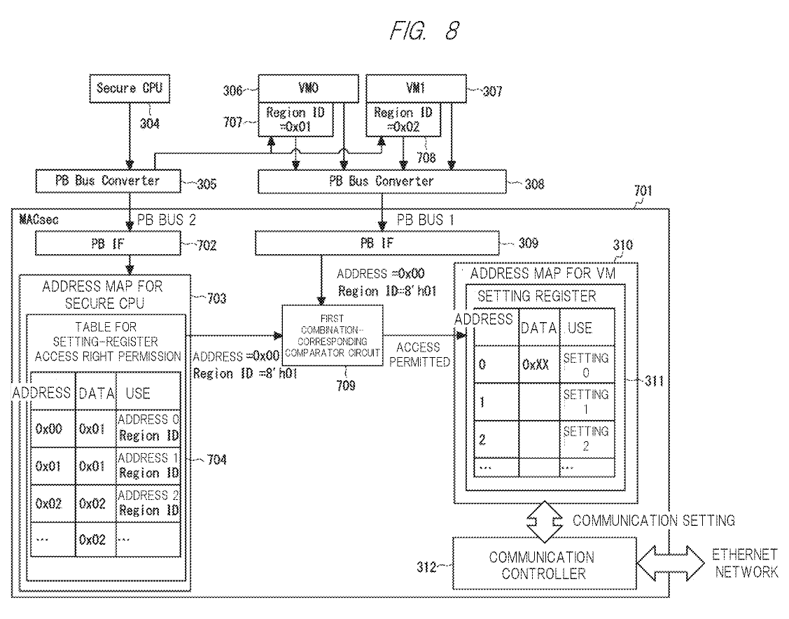

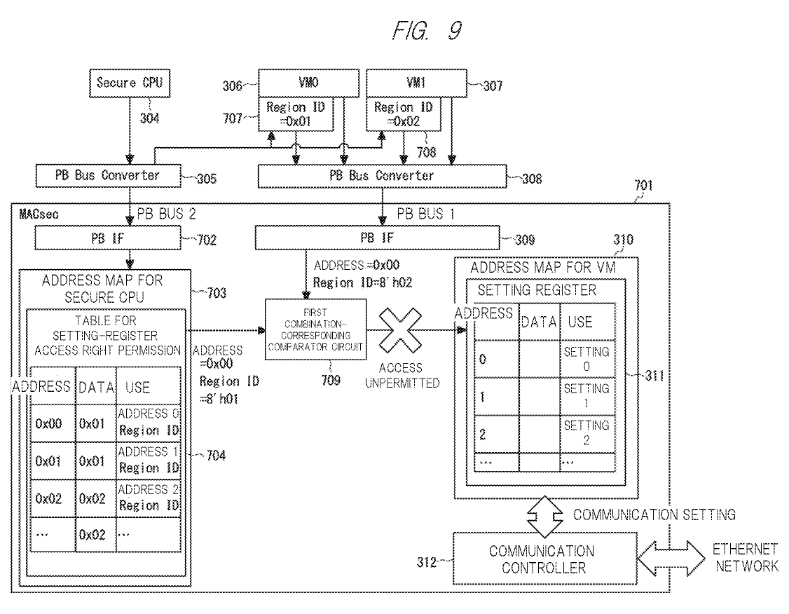

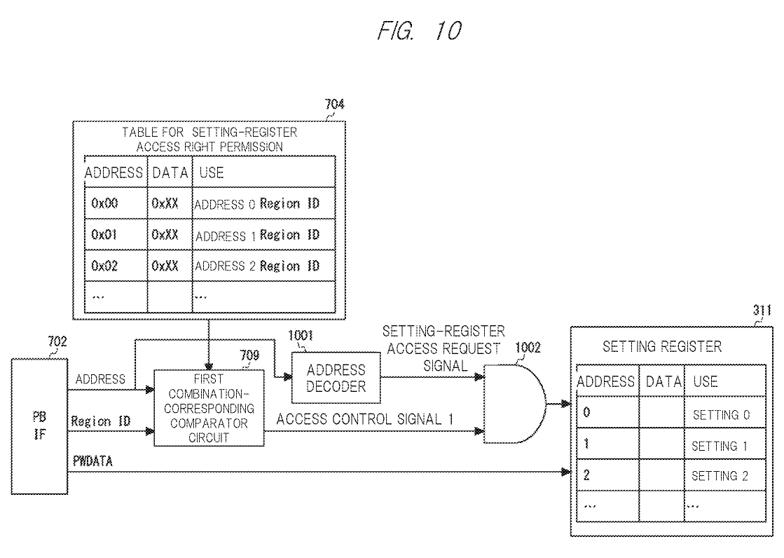

FIG. 8 is a block diagram illustrating an example of the access permission using a configuration, particularly the table for setting-register access right permission and the first combination-corresponding comparator circuit, of the MACsec according to the present disclosure. FIG. 9 is a block diagram illustrating an example of the access block using a configuration, particularly the table for setting-register access right permission and the first combination-corresponding comparator circuit, of the MACsec according to the present disclosure. FIG. 10 is a diagram illustrating an example of the access control using the table for setting-register access right permission and the first combination-corresponding comparator circuit according to the present disclosure. The first block of the semiconductor device according to the embodiment will be explained with reference to FIGS. 8 to 10. The explanation described here will be made while either the VM0 or the VM1 is described as a first virtual machine.

As illustrated in FIG. 8, it is assumed that, for example, the VM0(306) accesses the MACsec 701. The region ID 707 is previously provided to the VM0(306) by the secure CPU 304. The region ID 707 is “0x01”. When the VM0(306) attempts to change data (PWDATA) on an address 0x00, the VM0(306) accesses the first combination-corresponding comparator circuit 709 through the PB bus converter 308 and the PB IF 309. The first combination-corresponding comparator circuit 709 accesses the table 704 for setting-register access right permission of the address map 703 for secure CPU, and determines whether or not there is the correspondence in the combination of the stored region ID and the address. In this example, since there is the correspondence in the combination of the address 0x00 and the region ID 0x00, the access to the setting register 311 from the VM0(306) is permitted.

As illustrated in FIG. 9, it is assumed that the VM1(307) is hacked and spoofed and then attempts to access the address 0x00 of the setting register 311. A region ID 708 is previously provided to the VM1(307) by the secure CPU 304. The region ID 708 is “0x02”. When the VM1(307) attempts to change the data (PW DATA) on the address 0x00, the VM1(307) accesses the first combination-corresponding comparator circuit 709 through the PB bus converter 308 and the PB IF 309. The first combination-corresponding comparator circuit 709 accesses the table 704 for setting-register access right permission of the address map 703 for secure CPU, and determines whether or not there is the correspondence in the combination of the stored region ID and the address. In this example, since there is no correspondence in the combination of the address 0x00 and the region ID 0x01, the access to the setting register 311 from the VM0(307) is denied and blocked.

As illustrated in FIG. 10, in the table 704 for setting-register access right permission, the region ID of the VM to be permitted for the access is set for each address of each setting register. The VM0(306) or the VM1(307) transmits the address, the region ID and the PWDATA through the PB IF 702. The first combination-corresponding comparator circuit 709 receives the address and the region ID. The first combination-corresponding comparator circuit 709 accesses the table 704 for setting-register access right permission, and determines whether or not there is the correspondence in the combination of the region ID and the address. If there is the correspondence, the first combination-corresponding comparator circuit 709 generates an access control signal 1. The address is input to an address decoder 1001. The address decoder 1001 outputs a setting-register access request signal. The access control signal 1 and the setting-register access request signal are input to an AND circuit 1002, and a logical conjunction is output. As described above, the writing onto the setting register is blocked.

### Explanation for Second Block of Semiconductor Device according to Embodiment

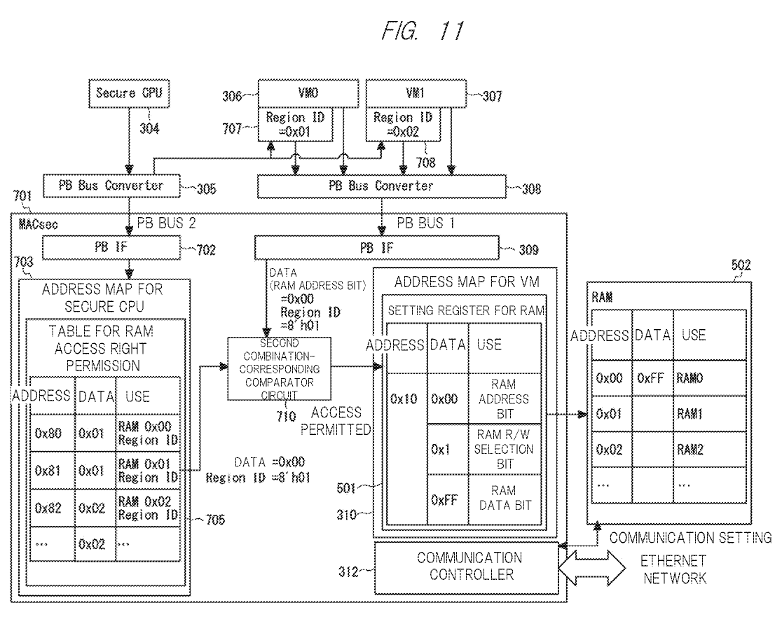

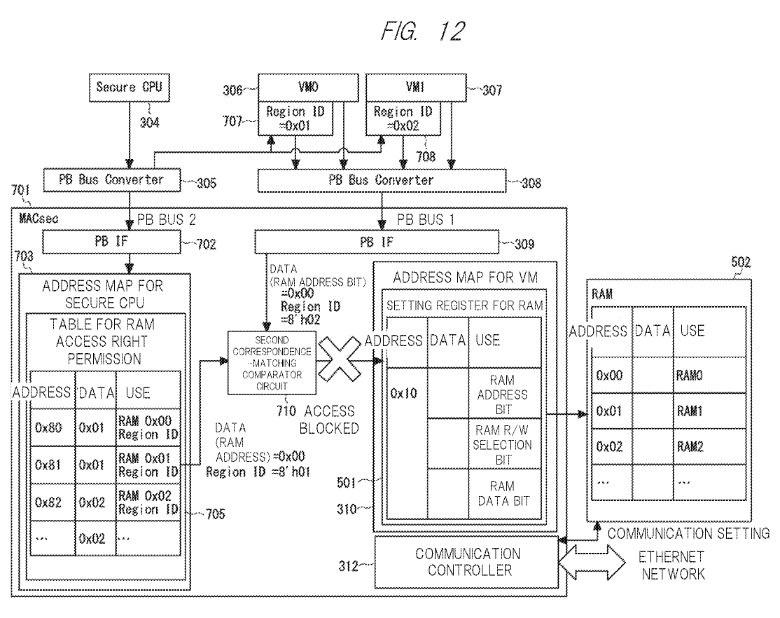

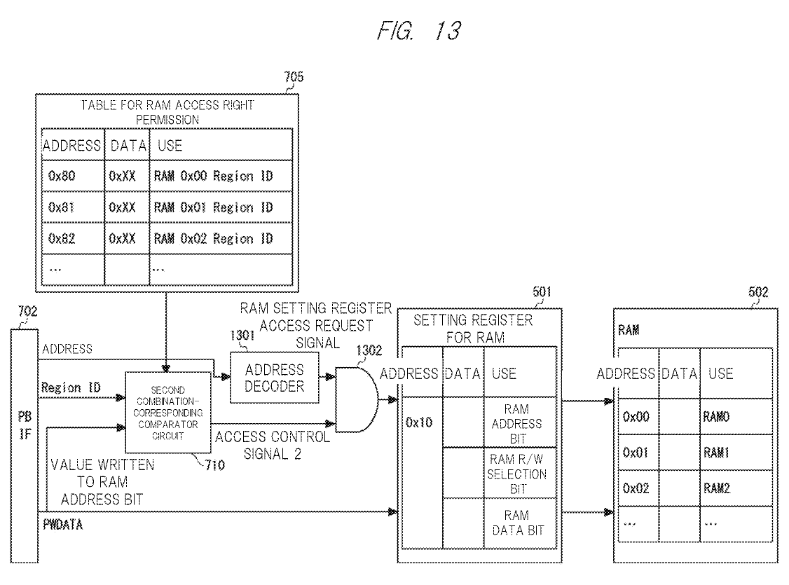

FIG. 11 is a block diagram illustrating an example of the access permission using a configuration, particularly the table for RAM access right permission and the second combination-corresponding comparator circuit, of the MACsec according to the present disclosure. FIG. 12 is a block diagram illustrating an example of the access block using a configuration, particularly the table for RAM access right permission and the second combination-corresponding comparator circuit, of the MACsec according to the present disclosure. FIG. 13 is a diagram illustrating an example of the access control using the table for RAM access right permission and the second combination-corresponding comparator circuit according to the present disclosure. The second block of the semiconductor device according to the embodiment will be explained with reference to FIGS. 11 to 13.

As illustrated in FIG. 11, it is assumed that, for example, the VM0(306) attempts to access the MACsec 701. The region ID 707 is previously provided to the VM0(306) by the secure CPU 304. The region ID 707 is “0x01”. When the VM0(306) attempts to change data (PWDATA) on a RAM address bit 0x00, the VM0(306) accesses the second combination-corresponding comparator circuit 710 through the PB bus converter 308 and the PB IF 309. The second combination-corresponding comparator circuit 710 accesses the table 705 for RAM access right permission of the address map 703 for secure CPU, and determines whether or not there is the correspondence in the combination of the stored region ID and the RAM address. In this example, since there is the correspondence in the combination of the RAM address bit 0x00 and the region ID 0x01, the access to the RAM 502 from the VM0(306) through the RAM setting register 501 is permitted.

As illustrated in FIG. 12, it is assumed that the VM1(307) is hacked and spoofed and then attempts to access the RAM 502. The region ID 708 is previously provided to the VM1(307) by the secure CPU 304. The region ID 708 is “0x02”. When the VM1(307) attempts to change the data (PWDATA) on the RAM address bit 0x00, the VM1(307) accesses the second combination-corresponding comparator circuit 710 through the PB bus converter 308 and the PB IF 309. The second combination-corresponding comparator circuit 710 accesses the table 705 for RAM access right permission of the address map 703 for secure CPU, and determines whether or not there is the correspondence in the combination of the stored region ID and the address. In this example, since there is no correspondence in the combination of the RAM address bit 0x00 and the region ID 0x02, the access to the RAM 502 from the VM1(307) through the RAM setting register 501 is denied and blocked.

As illustrated in FIG. 13, the table 705 for RAM access right permission has a (direct) VM access destination for permitting each VM to access a (indirect) VM access destination for each VM. In other words, the table 705 for RAM access right permission has the region ID of the VM permitted to access each RAM address. The PWDATA is the RAM access bit, the RAM R/W selection bit or the RAM data bit. The VM0(306) or the VM1(307) transmits the address, the region ID and the PWDATA through the PB IF 702. The second combination-corresponding comparator circuit 710 receives the RAM access bit and the region ID. The second combination-corresponding comparator circuit 710 accesses the table 705 for RAM access right permission, and determines whether or not there is the correspondence in the combination of the RAM address bit and the region ID. If there is the correspondence, the second combination-corresponding comparator circuit 710 generates an access control signal 2. The address is input to an address decoder 1301. The address decoder 1301 outputs a RAM setting-register access request signal. The access control signal 2 and the setting-register access request signal are input to an AND circuit 1302, and a logical conjunction is output. As described above, the access to the RAM setting register is blocked.

As described above, against the risk of the falsification of the MACsec setting value of the different VM by the hacked VM, the secure CPU 304 assigns the region where the key information, the setting register or the like can be set for each VM, and the MACsec denies the access other than the access from the assigned VM. Therefore, the illegitimate access from the illegitimate VM can be immediately blocked, and thus, the MACsec setting value cannot be falsified by the illegitimate VM. Accordingly, the communication malfunction can be prevented.

### Explanation for Isolation of Semiconductor Device according to Embodiment

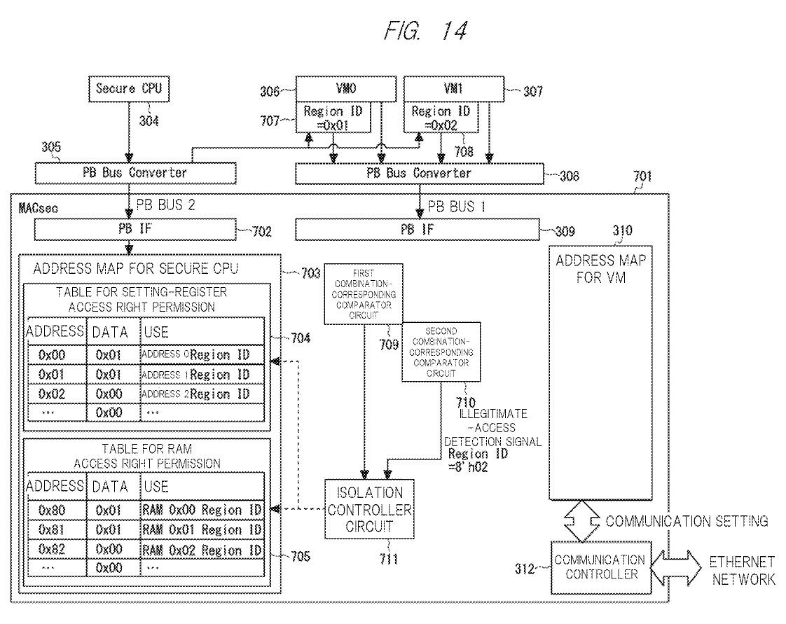

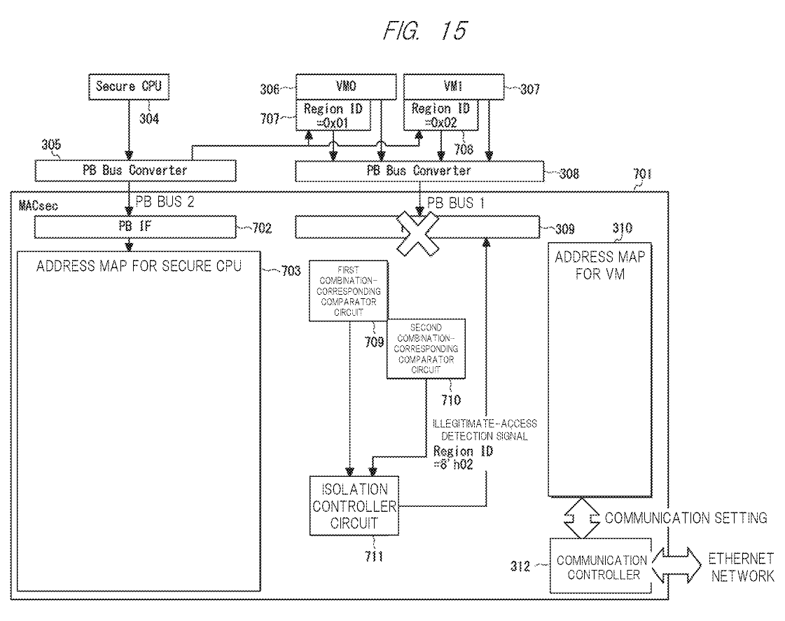

FIG. 14 is a block diagram illustrating a first example of the isolation using a configuration, particularly the isolation controller circuit, of the MACsec according to the present disclosure. FIG. 15 is a block diagram illustrating a second example of the isolation using the configuration, particularly the isolation controller circuit, of the MACsec according to the present disclosure. The isolation of the semiconductor device according to the embodiment will be explained with reference to FIGS. 14 and 15.

The first example will be explained. As illustrated in FIG. 14, if it is determined that there is no correspondence as a result of the comparison in the correspondence made by the first combination-corresponding comparator circuit 709, the first combination-corresponding comparator circuit 709 notifies the isolation controller circuit 711 of an illegitimate-access detection signal and the region ID of the illegitimately-accessing VM. Alternatively, if it is determined that there is no correspondence as a result of the comparison in the correspondence made by the second combination-corresponding comparator circuit 710, the second combination-corresponding comparator circuit 710 notifies the isolation controller circuit 711 of the illegitimate-access detection signal and the region ID of the illegitimately-accessing VM. In response to this, the isolation controller circuit 711 isolates the illegitimately-accessing VM by searching the region ID of the illegitimately-accessing VM from the insides of the table 704 for setting-register access right permission and the table 705 for RAM access right permission, and then, by forcible rewriting.

The second example will be explained. As illustrated in FIG. 15, if it is determined that there is no correspondence as a result of the comparison in the correspondence made by the first combination-corresponding comparator circuit 709, the first combination-corresponding comparator circuit 709 notifies the isolation controller circuit 711 of the illegitimate-access detection signal and the region ID of the illegitimately-accessing VM. Alternatively, if it is determined that there is no correspondence as a result of the comparison in the correspondence made by the second combination-corresponding comparator circuit 710, the second combination-corresponding comparator circuit 710 notifies the isolation controller circuit 711 of the illegitimate-access detection signal and the region ID of the illegitimately-accessing VM. The isolation controller circuit 711 holds the region ID value of the illegitimately-accessing VM, and then, if it is determined that there is the correspondence as a result of the comparison in the correspondence between the region ID value of the accessing VM and the region ID held by the isolation controller circuit 711 at the time of the subsequent access to the MACsec 701 from the VM, isolates the illegitimately-accessing VM by denying the access.

Against the risk of the falsification on the setting of the MACsec assigned to the hacked VM by this VM, when the MACsec blocks the illegitimate access, the MACsec stops the access right of this VM, and denies all accesses after that. Therefore, by the stop of the access right of the illegitimate VM made by the MACsec, the illegitimate VM is isolated from the MACsec control. Accordingly, the access (writing/reading) to the MACsec from the illegitimate VM is completely invalidated, and therefore, the MACsec internal information is protected from the illegitimate VM.

### Explanation for Protection of Semiconductor Device according to Embodiment

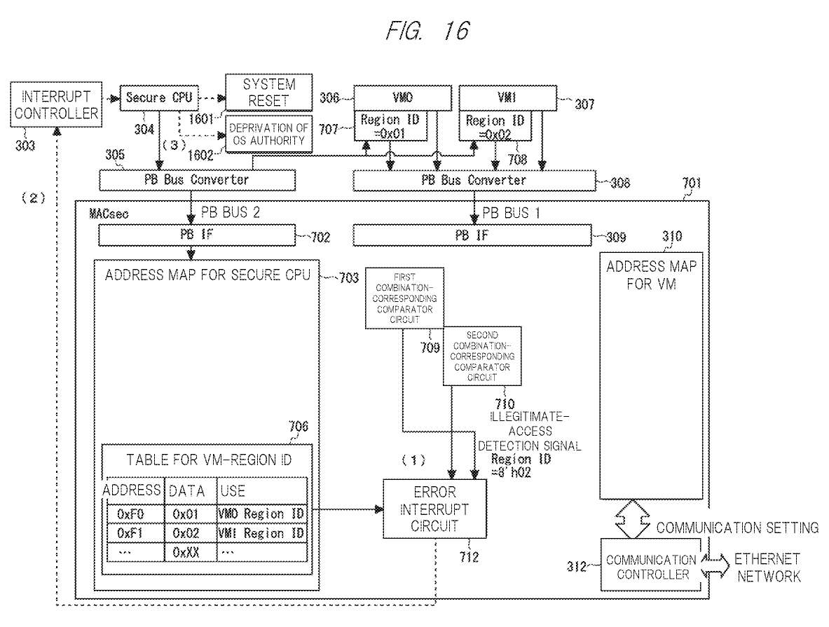

FIG. 16 is a block diagram illustrating an example of the protection for the attacked virtual machine, using a configuration, particularly the error interrupt circuit, of the MACsec according to the present disclosure. The protection of the semiconductor device according to the embodiment will be explained with reference to FIG. 16.

The error interrupt circuit 712 receives the illegitimate-access detection signal and the region ID from the first combination-corresponding comparator circuit 709 or the second combination-corresponding comparator circuit 710. The error interrupt circuit 712 refers to a table 706 for VM-region ID (virtual machine-region ID table), identifies the illegitimately-accessing VM, and sets an error interrupt of a corresponding VM number (1). The error interrupt circuit 712 notifies the secure CPU 304 of the illegitimate VM through the interrupt controller 303 (2). The secure CPU 304 executes a reset 1601 to the entire relating system of the spoofed VM. Also, the secure CPU 304 executes a revocation 1602 to an OS permission of the illegitimate VM (3). As described above, the entire system is protected from the attack of the spoofed VM.

Against a problem that is failure in the control executed by the hacked VM because of the stop of this VM, when the MACsec 701 blocks the illegitimate access, the MACsec 701 notifies the secure CPU 304 of the illegitimate access. The notified secure CPU 304 stops the illegitimately-accessing VM, and restores it by the reset or the like. Therefore, the influence of the illegitimate operation of the illegitimate VM onto the system is minimized, and the system can be normalized or restored to an almost normalized state.

### Explanation for Method of Block, Isolation and Protection of Semiconductor Device according to Embodiment

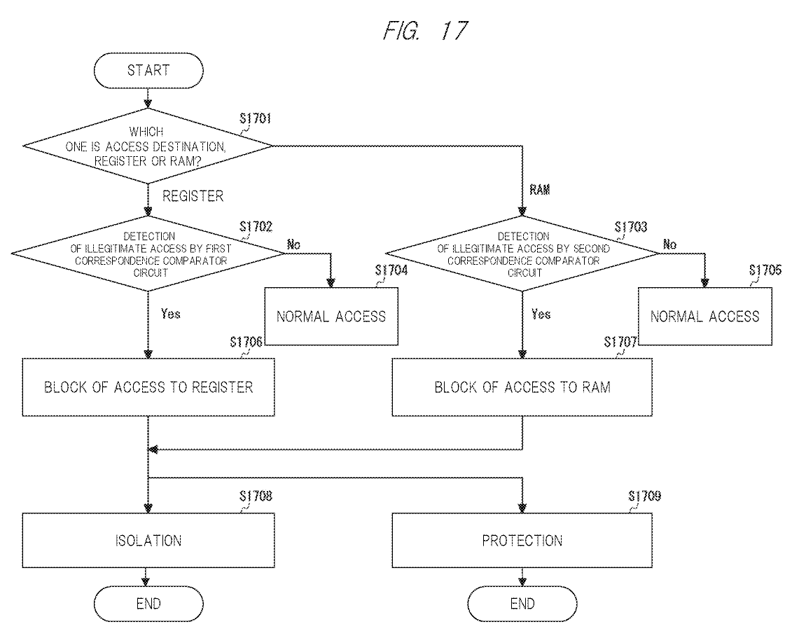

FIG. 17 is a flowchart of the access control according to the present disclosure. The method of the block, isolation and protection of the semiconductor device according to the embodiment will be explained with reference to FIG. 17.

As illustrated in FIG. 17, first, it is determined which one of the register and the RAM the access destination is (step S1701). In a case of the register, the illegitimate access is detected by the first combination-corresponding comparator circuit (step S1702). The first combination-corresponding comparator circuit 709 determines whether or not there is the correspondence in the combination of the address and the region ID.

If the illegitimate access is not detected (in a case “No” of the step S1702), in other words, if there is the correspondence in the combination of the address and the region ID, the normal access is made (step S1704).

If the illegitimate access is detected (in a case “Yes” of the step S1702), in other words, if there is no correspondence in the combination of the address and the region ID, the access to the register is blocked (step S1706). Then, the isolation (step S1708) and the protection (step S1709) are executed, and the processing ends. That is, the illegitimate VM is isolated and reset.

In a case of the RAM, the illegitimate access is detected by the second combination-corresponding comparator circuit (step S1703). The second combination-corresponding comparator circuit 710 determines whether or not there is the correspondence in the combination of the RAM bit address and the region ID.

If the illegitimate access is not detected (in a case “No” of the step S1703), in other words, if there is the correspondence in the combination of the RAM bit address and the region ID, the normal access is made (step S1705).

If the illegitimate access is detected (in a case “Yes” of the step S1703), in other words, if there is no correspondence in the combination of the RAM bit address and the region ID, the access to the RAM is blocked (step S1707). Then, the isolation (step S1708) and the protection (step S1709) are executed, and the processing ends. That is, the illegitimate VM is isolated and reset.

As described above, the block, the isolation and the protection of the semiconductor de vice are executed.

Note that the present invention is not limited to the above-described embodiments, and various modifications can be made within the scope of the present invention.

What is claimed is:

1. A semiconductor device comprising:
a table for setting-register access right permission, connected to a secure CPU and storing a region ID and an address of a virtual machine; and
a first combination-corresponding comparator circuit determining whether or not a region ID of a first virtual machine for changing a setting register and an address assigned by the first virtual machine correspond to the region ID and the address of the virtual machine stored in the table for setting-register access right permission.

2. The semiconductor device according to claim 1,
wherein a PB bus connecting the secure CPU to the table for setting-register access right permission is different from a PB bus connecting the first virtual machine to the first combination-corresponding comparator circuit.

3. The semiconductor device according to claim 1,
wherein if the first combination-corresponding comparator circuit determines that the region ID of the first virtual machine and the address assigned by the first virtual machine correspond to the region ID and the address of the virtual machine stored in the table for setting-register access right permission, access to the setting register from the first virtual machine is permitted, and
if the first combination-corresponding comparator circuit determines that the region ID of the first virtual machine and the address assigned by the first virtual machine does not correspond to the region ID and the address of the virtual machine stored in the table for setting-register access right permission, access to the setting register from the first virtual machine is blocked.

4. The semiconductor device according to claim 1,
wherein if the first combination-corresponding comparator circuit determines that the region ID of the first virtual machine and the address assigned by the first virtual machine does not correspond to the region ID and the address of the virtual machine stored in the table for setting-register access right permission, an isolation controller circuit rewrites data of the table for setting-register access right permission such that the first virtual machine is isolated from accessing to the setting register.

5. The semiconductor device according to claim 2,
wherein if the first combination-corresponding comparator circuit determines that the region ID of the first virtual machine and the address assigned by the first virtual machine does not correspond to the region ID and the address of the virtual machine stored in the table for setting-register access right permission, an isolation controller circuit controls the PB bus connecting the first virtual machine to the first combination-corresponding comparator circuit such that the first virtual machine is isolated from accessing to the first combination-corresponding comparator circuit.

6. The semiconductor device according to claim 1,
wherein if the first combination-corresponding comparator circuit determines that the region ID of the first virtual machine and the address assigned by the first virtual machine does not correspond to the region ID and the address of the virtual machine stored in the table for setting-register access right permission,
an error interrupt circuit refers to a table for virtual machine-region ID storing set virtual machine and region ID, and identifies the first virtual machine,
the error interrupt circuit notifies the secure CPU of the first virtual machine, and
the secure CPU resets the first virtual machine.

7. A semiconductor device comprising:
a table for RAM access right permission, connected to a secure CPU and storing a region ID and an address of a virtual machine; and
a second combination-corresponding comparator circuit determining whether or not a region ID of a first virtual machine for changing a RAM and an address assigned by the first virtual machine correspond to the region ID and the address of the virtual machine stored in the table for RAM access right permission.

8. The semiconductor device according to claim 7,
wherein a PB bus connecting the secure CPU to the table for RAM access right permission is different from a PB bus connecting the first virtual machine to the second combination-corresponding comparator circuit.

9. The semiconductor device according to claim 7,
wherein if the second combination-corresponding comparator circuit determines that the region ID of the first virtual machine and the address assigned by the first virtual machine correspond to the region ID and the address of the virtual machine stored in the table for RAM access right permission, access to a setting register for RAM from the first virtual machine is permitted, and
if the second combination-corresponding comparator circuit determines that the region ID of the first virtual machine and the address assigned by the first virtual machine does not correspond to the region ID and the address of the virtual machine stored in the table for RAM access right permission, access to the setting register for RAM from the first virtual machine is blocked.

10. The semiconductor device according to claim 7,
wherein if the second combination-corresponding comparator circuit determines that the region ID of the first virtual machine and the address assigned by the first virtual machine does not correspond to the region ID and the address of the virtual machine stored in the table for RAM access right permission, an isolation controller circuit rewrites data of the table for RAM access right permission such that the first virtual machine is isolated from accessing to the setting register for RAM.

11. The semiconductor device according to claim 8,
wherein if the second combination-corresponding comparator circuit determines that the region ID of the first virtual machine and the address assigned by the first virtual machine does not correspond to the region ID and the address of the virtual machine stored in the table for RAM access right permission, an isolation controller circuit controls the PB bus connecting the first virtual machine to the second combination-corresponding comparator circuit such that the first virtual machine is isolated from accessing to the second combination-corresponding comparator circuit.

12. The semiconductor device according to claim 7,
wherein if the second combination-corresponding comparator circuit determines that the region ID of the first virtual machine and the address assigned by the first virtual machine does not correspond to the region ID and the address of the virtual machine stored in the table for RAM access right permission,
an error interrupt circuit refers to a table for virtual machine-region ID storing set virtual machine and region ID, and identifies the first virtual machine,
the error interrupt circuit notifies the secure CPU of the first virtual machine, and
the secure CPU resets the first virtual machine.
